(19) United States
(12) Patent Application Publication
(10) Pub. No.: US 2025/0301243 A1
(43) Pub. Date: Sep. 25, 2025

(54) ATTENTION-ORIENTED REGION-BASED PROCESSING FOR NEAR-SENSOR KNOWLEDGE INFERENCE OF IMAGE DATA

(71) Applicant: University of Florida Research Foundation, Incorporated, Gainesville, FL (US)

(72) Inventors: Christophe Bobda, Gainesville, FL (US); Peter Mbua, Gainesville, FL (US)

(21) Appl. No.: 19/084,424

(22) Filed: Mar. 19, 2025

Related U.S. Application Data
(60) Provisional application No. 63/568,038, filed on Mar. 21, 2024.

(51) Int. Cl. H04N 25/79; G06V 10/147; G06V 10/70; G06V 10/94; H04N 23/80

(52) U.S. Cl. CPC H04N 25/79; G06V 10/147; G06V 10/70; G06V 10/955; H04N 23/80

(57) ABSTRACT

An in/near-sensor artificial intelligence (AI) architecture that facilitates knowledge inference at a source of data, wherein the architecture comprises a three-dimensional (3D) stacked complementary metal-oxide-semiconductor (CMOS) image sensor that comprises a multi-layer computational structure that enables AI-based knowledge inference before readout electronics. The multi-layer computational structure comprises a hierarchical attention-oriented region-based processing (HARP) module that is configured between a processing unit and readout circuitry that is coupled to an image sensor.

### CROSS REFERENCE TO RELATED APPLICATION

This application claims the priority of U.S. Provisional Application No. 63/568,038, entitled “ATTENTION-ORIENTED REGION-BASED PROCESSING FOR NEAR-SENSOR KNOWLEDGE INFERENCE OF IMAGE DATA,” filed on Mar. 21, 2024, the disclosure of which is hereby incorporated by reference in its entirety.

### GOVERNMENT SUPPORT

This invention was made with government support under 1946088 awarded by The National Science Foundation. The government has certain rights in the invention.

### TECHNICAL FIELD

Various embodiments of the present disclosure relate to near-sensor data processing, and more particularly to performing attention-oriented region-based image pre-processing on an image sensor.

### BACKGROUND

Infrared (IR) image sensors may be used in a variety of applications due to their durability in harsh environments, such as in conditions with fog, haze, smoke, and/or water vapor. Example applications of IR image sensors may comprise human/object movement monitoring, chemical, biological, radiological, and nuclear defense (CBRNE) detection, small-object detection from cluttered maritime scenes, missile detection, robotics, autonomous vehicle, and remote sensing using drones. IR image sensors may be further used in edge devices that require low latency and real-time processing at or close to a source of data.

Near-sensor and in-sensor techniques may be configured to process device sensory data as close as possible to a sensor in order to reduce data transmission overhead and latency between the sensor and a data processor. As such, various benefits may be achieved by configuring sensors in close proximity to a data processor, such as reduced data transmission where fewer data may be transmitted to the data processor, as well as, saving bandwidth and power consumption. Additionally, improved data privacy may be provided by preprocessing/processing and protecting sensitive data on a sensor before exposing the data to other parts of a system. The aforementioned benefits are especially relevant in the case of low-power, real-time on-site processing of raw sensory data.

However, applicant has identified many technical challenges and difficulties associated with implementing near-sensor and in-sensor devices.

### BRIEF SUMMARY

Various embodiments described herein relate to apparatus, systems, computing devices, computing entities, and/or the like for increasing performance of imaging systems.

According to some embodiments, an image processing system comprises an hierarchical processing device that is configured between readout circuitry of an image sensor and a signal processing unit, wherein the hierarchical processing device comprises a first processing circuit layer configured to (i) generate image data that is associated with the image sensor and (ii) generate a subset of the image data by performing pre-processing on the image data, wherein the subset of the image data comprises pixel intensity values that are associated with an image region of a plurality of image regions; and a second processing circuit layer configured to (i) receive the subset of the image data from the first processing circuit layer and (ii) generate feedback output by performing inference-based processing on the subset of the image data.

In some embodiments, the first processing circuit layer is further configured to sense image regions with a frequency based on the feedback output. In some embodiments, the first processing circuit layer is configured to generate the subset of the image data by filtering redundant spatiotemporal data from the image data. In some embodiments, the image processing system further comprises an in-sensor architecture or a near-sensor architecture. In some embodiments, the image processing system further comprises an integration of the image sensor and the first processing circuit layer on a system on a chip. In some embodiments, the first processing circuit layer comprises an attention-based pre-processing layer that is configured to perform attention-oriented region-based pre-processing on the image data. In some embodiments, the attention-based pre-processing layer comprises an image acquisition circuit and a region-based processing module.

In some embodiments, the region-based processing module comprises one or more pixel processing elements. In some embodiments, the attention-based pre-processing layer is coupled to an inference computational layer that comprises the second processing circuit layer. In some embodiments, the inference computational layer is configured to perform application-specific computations. In some embodiments, the application-specific computations are associated with object detection or scene recognition. In some embodiments, the subset of the image data is associated with an image region.

According to some embodiments, a three-dimensional stacked complementary metal-oxide-semiconductor is provided. In some embodiments, the three-dimensional stacked complementary metal-oxide-semiconductor comprises a pixel substrate that includes one or more photo-sensing elements; a logic substrate that includes a signal processing unit; one or more vertical interconnects that transfer pixel intensity values from the pixel substrate to the logic substrate; and an hierarchical attention-oriented region-based processing module that is coupled to an inference engine, the hierarchical attention-oriented region-based processing module configured to (i) receive image data from pixel readout circuitry that is coupled to the pixel substrate; (ii) identify high-level information associated with the image data; and (iii) transfer salient information based on the high-level information to the inference engine.

In some embodiments, the inference engine comprises a deep learning inference module. In some embodiments, the deep learning inference module is configured by using a region-aware event-based simulator and a configuration generator module to train a machine learning model based on one or more operators and/or event-based models. In some embodiments, the region-aware event-based simulator and the configuration generator module are configured to generate one or more system configurations based on one or more simulation results that are associated with one or more physical properties of the one or more photo-sensing elements. In some embodiments, the deep learning inference module is configured with the one or more system configurations.

According to some embodiments, an image processing system comprises an image sensor that is configured to generate image data for each of a plurality of image frames; a frame buffer; a field-programmable gate array that is configured to receive the image data from the image sensor, the field-programmable gate array comprising: an input controller that is configured to (i) store the plurality of image frames to the frame buffer and (ii) provide access to at least a portion of the plurality of image frames from the frame buffer; and an hierarchical attention-oriented region-based processing module configured to perform attention oriented region-based processing of at least the portion of the plurality of image frames.

### BRIEF DESCRIPTION OF THE DRAWINGS

Embodiments incorporating teachings of the present disclosure are shown and described with respect to the figures presented herein.

FIG. 1A depicts an example architecture of a near-sensor image processing system in accordance with some embodiments of the present disclosure.

FIG. 1B depicts an example architecture of an in-sensor image processing system in accordance with some embodiments of the present disclosure.

FIG. 2A depicts an example architecture of a 3D-stacked CMOS image sensor in accordance with some embodiments of the present disclosure.

FIG. 2B depicts an example architecture of an in/near-sensor image processing system in accordance with some embodiments of the present disclosure.

FIG. 3 depicts an example schematic diagram of a 3D-stacked CMOS image sensor in accordance with some embodiments of the present disclosure.

FIG. 4 depicts an example pixel readout circuitry in accordance with some embodiments of the present disclosure.

FIG. 5 depicts an example architecture of an in/near-sensor image processing system in accordance with various embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

There are currently no solutions that fulfill the need for integrating both computing and sensing functionality at a network edge. Sensors may be limited to sensing and noise reductions, whereas edge devices may be intended for general-purpose computing, thereby involving substantial cooling, space, and power constraints and/or conditions. Additionally, certain sensors, such as event cameras, may reduce data transfer from the sensor to a back end but do not integrate computation, which is performed in the back end after an image is reconstructed. Thus, event cameras are used in combination with a back-end processor to reconstruct frames before applying knowledge inference.

According to various embodiments of the present disclosure, an in/near-sensor artificial intelligence (AI) architecture is provided that facilitates knowledge inference at a source of data (e.g., sensor) to increase the performance of imaging systems, e.g., at the network edge, while reducing power, without loss of inference accuracy. The disclosed in/near-sensor AI architecture may address the challenge of gigapixel image sensors by integrating knowledge inference at the source of image data. For example, readout circuitry may sequentially transfer pixel intensity values from a sensor device to a host processor (e.g., an image processor) or peripherals to perform further processing. Accordingly, the present application discloses a three-dimensional (3D) stacked complementary metal-oxide-semiconductor (CMOS) image sensor that comprises a multi-layer computational structure that enables AI-based knowledge inference before readout electronics. In some embodiments, the multi-layer computational structure further comprises a hierarchical attention-oriented region-based processing (HARP) module that is configured between a processing unit and readout circuitry that is coupled to an image sensor. In some embodiments, the HARP module extracts global information of an image frame by employing parallelism while consuming low power. Thus, by providing knowledge inference at a source of data through efficient AI implementation, power, cost, and latency may be reduced, thereby making the disclosed in/near-sensor AI architecture suitable for edge devices.

### Example Technical Implementation of Various Embodiments

According to various embodiments of the present disclosure, in/near-sensor processing systems and methods are provided for efficient sensory data pre-processing that reduces data transfer between a sensor and an application processor (on-board or external). In some embodiments, an in/near-sensor image processing system comprises one or more stand-alone image sensors that are attached to a processing subsystem. For example, an in/near-sensor image processing system may comprise a planar system on a chip (SoC) with an image sensor and a low-level processor on a same substrate, e.g., as 2.5D chiplets integration or as printed circuit board (PCB) integration.

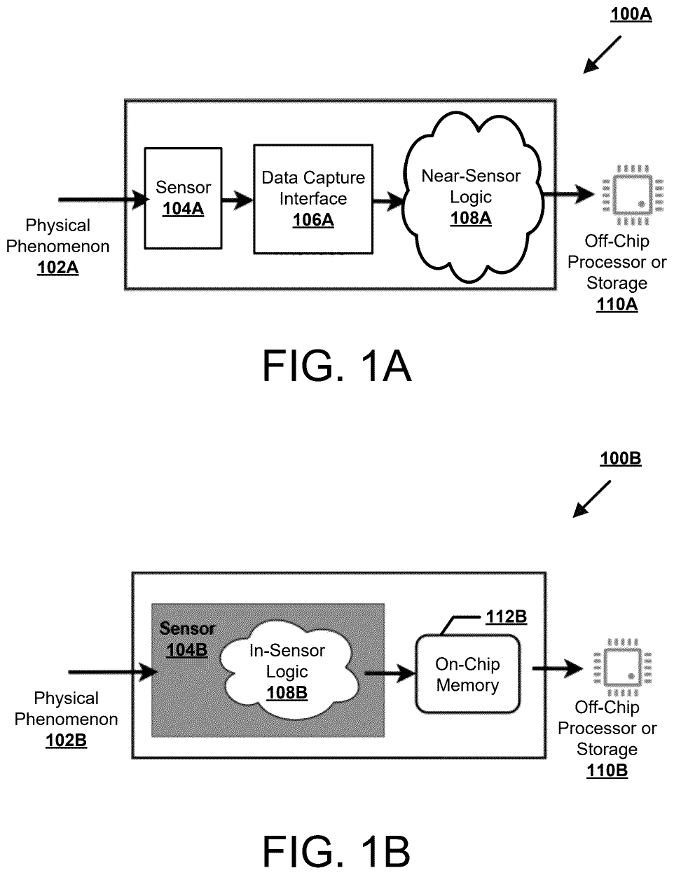

Example near-sensor and in-sensor architectures are depicted in FIG. 1A and FIG. 1B, respectively. Near-sensor systems are distinguished from in-sensor systems by the proximity of first-level processing to a sensing unit(s). FIG. 1A depicts an example architecture of a near-sensor image processing system 100A in accordance with some embodiments of the present disclosure. As depicted in FIG. 1A, the near-sensor image processing system 100A comprises a conspicuous sensing/processing interface in the form of a data capture interface 106A that is configured between sensing functionality via sensor 104A and low-level processing via near-sensor logic 108A. The sensor 104A may be configured to detect physical phenomenon (e.g., light, sound, etc.) that are converted into sensor values (e.g., analog) by the data capture interface 106A. The data capture interface 106A then transmits the sensor values to near-sensor logic 108A. The near-sensor logic 108A may pre-process and/or convert the sensor values into a format (e.g., digital) suitable for processing by an off-chip processor or storage 110A.

FIG. 1B depicts an example architecture of an in-sensor image processing system 100B in accordance with some embodiments of the present disclosure. In contrast to the near-sensor image processing system 100A, a sensing/processing interface is seamless in the in-sensor image processing system 100B. That is, low-level processing functionality is embedded in the sensory logic of sensor 104B via an in-sensor logic 108B, and thus, obviates an interface (such as data capture interface 106A) between sensing functionality and low-level processing. The sensor 104B may be configured to capture physical phenomenon (e.g., light, sound, etc.) and internally transmit sensor values (e.g., analog) to in-sensor logic 108B. The in-sensor logic 108B may pre-process and/or convert the sensor values (e.g., digital) into a format suitable for processing by an off-chip processor or storage 110B.

According to various embodiments of the present disclosure, an image processing system comprises a two-layer hierarchical system that provides attention-oriented region-based pre-processing (e.g., HARP) of image data (e.g., pixel intensity values) for filtering redundant spatiotemporal data from image data. In some embodiments, the image data comprises data representative of images over one or more frames and redundant spatiotemporal data comprises image background. A HARP module may be configured with either a near-sensor architecture or an in-sensor architecture. In some embodiments, a HARP module is configured between readout circuitry of a sensor (e.g., sensor 104A or sensor 104B) and a low-level processor (e.g., near-sensor logic 108A or in-sensor logic 108B).

In some embodiments, a HARP module comprises an attention-based pre-processing layer (APL) that is configured to perform filtering operations on image data by using a low-level processor, such as a signal processing unit. The APL may comprise an image acquisition circuit and a region-based processing module. The image acquisition circuit may comprise circuitry that is configured to sense images from an image sensor by generating raw image data (e.g., pixel intensity values). The region-based processing module may comprise one or more pixel processing elements (i.e., pixel processing units (PPUs)). In some embodiments, the APL is coupled to an inference computational layer (ICL) that comprises, for example, an off-chip high-level/application processor. High-level/application-specific image processing computations, such as for object detection and scene recognition, may be performed on the ICL.

The APL layer may process a smaller subset of image data, for example, pixel intensity values that are associated with an image region of a plurality of regions from an entire dataset (e.g., a large image), and transfer the processed subset of image data to the ICL. That is, the APL may extract relevant data from image regions and pass them as input to the ICL. The ICL may be configured to react to relevant data from the APL. For example, the HARP module may be configured at a low level to implement different event detection models and at a high level to implement various inference models. In some embodiments, the ICL comprises a deep learning inference module. Feedback (e.g., prediction output) may be generated by the ICL and provided to the ACL for adapting image sensing to a frequency that is proportional to relevance. For example, a large portion of an image may not be relevant for processing. Thus, corresponding image regions of the image may be sensed at a lower frequency/rate thereby increasing processing and power consumption may be reduced.

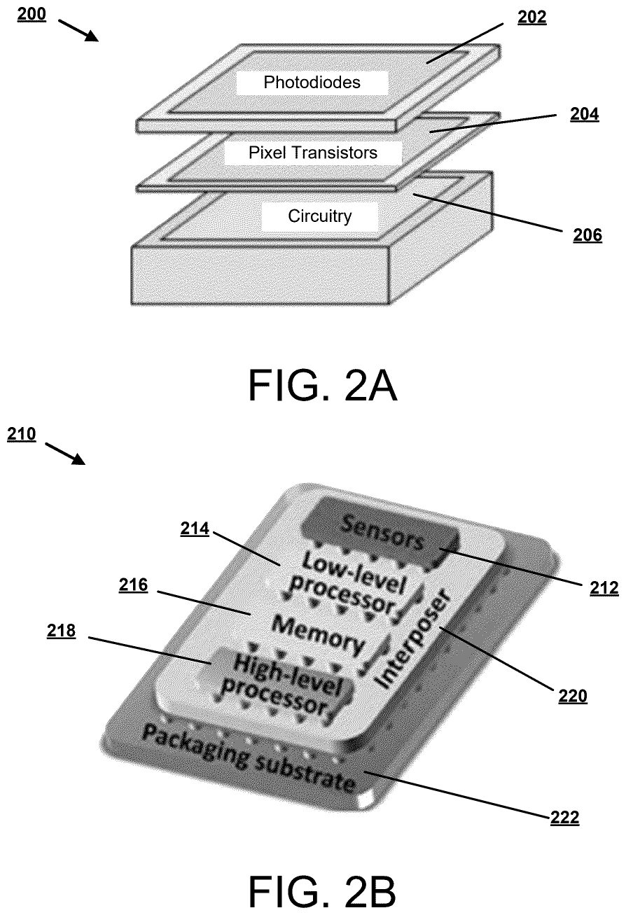

According to some embodiments, an in/near-sensor image processing system comprises a 3D-stacked CMOS image sensor that integrates sensing and processing functionalities. FIG. 2A depicts an example architecture of a 3D-stacked CMOS image sensor 200 in accordance with some embodiments of the present disclosure. The 3D-stacked CMOS image sensor 200 comprises a photodiodes layer 202, a pixel transistors layer 204, and a circuitry layer 206. The photodiodes layer 202 may comprise one or more photodiodes that are configured to convert light into electrical signals. The pixel transistors layer 204 may comprise one or more pixel transistors that are configured to convert the electrical signals generated by the photodiodes in the photodiodes layer 202 into signal voltages that may be processed by the circuitry layer 206.

FIG. 2B depicts an example architecture of an in/near-sensor image processing system 210 in accordance with some embodiments of the present disclosure. As depicted in FIG. 2B, a plurality of chips (sensors 212, low-level processor 214, memory 216, and high-level processor 218) are integrated on a single die of a packaging substrate 222 by using stacked silicon interconnect technology. Sensors 212 may comprise a plurality of 3D-stacked CMOS image sensors that are configured to sense images by generating raw image data (e.g., pixel intensity values) and provide the raw image data to low-level processor 214. Low-level processor 214 may be configured to generate pre-processed image data by performing low-level processing of the raw image data. An example of low-level processing may include, but is not limited to, generating a subset of the raw image data by filtering of redundant spatiotemporal data from the raw image data over one or more frames. Memory 216 may be configured to provide a frame buffer. For example, low-level processor 214 may access a buffer of image frames via memory 216 to perform attention oriented region-based processing (e.g., processing one or more portions of a whole image). High-level processor 218 may be configured to perform application-specific processing on pre-processed image data generated by the low-level processor 214. For example, application-specific processing may comprise processing associated with motion detection, scene recognition, or object detection.

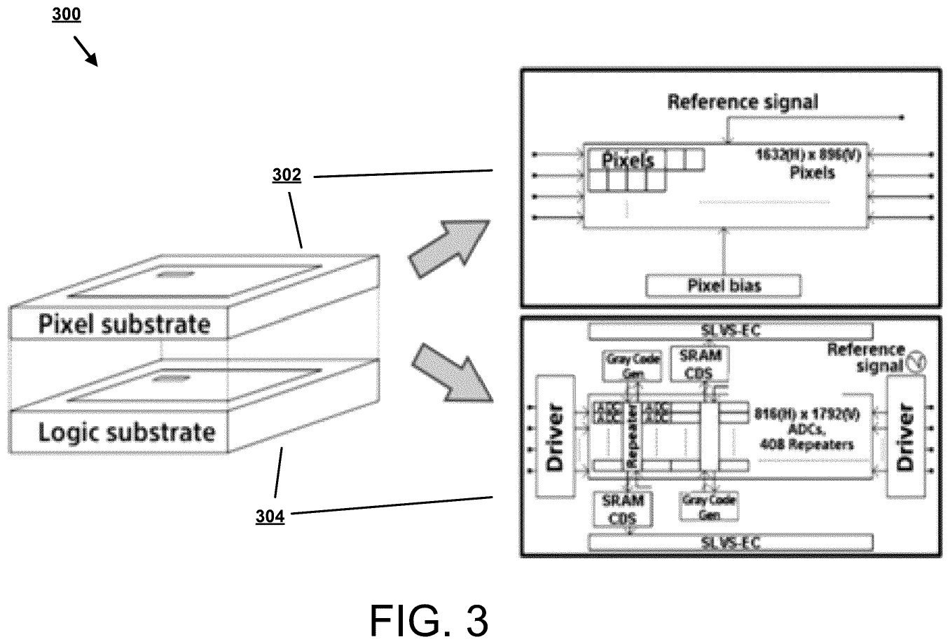

FIG. 3 depicts an example schematic diagram of a 3D-stacked CMOS image sensor 300 in accordance with some embodiments of the present disclosure. The 3D-stacked CMOS image sensor 300 comprises a pixel substrate 302 that is configured as a top substrate and a logic substrate 304 that is configured as a bottom substrate. The pixel substrate 302 comprises one or more photo-sensing elements (e.g., one or more photodiodes and/or pixel transistors). The logic substrate 304 comprises a signal processing unit (e.g., analog to digital converter (ADC) array) for digitizing analog pixel (e.g., intensity) values received from the one or more photo-sensing elements in parallel. The 3D-stacked CMOS image sensor 300 may further comprise one or more vertical interconnects that transfer pixel intensity values from the pixel substrate 302 to the logic substrate 304. In some embodiments, the 3D-stacked CMOS image sensor 300 further comprises a multi-layer computational structure that provides the 3D-stacked CMOS image sensor 300 with active device capabilities.

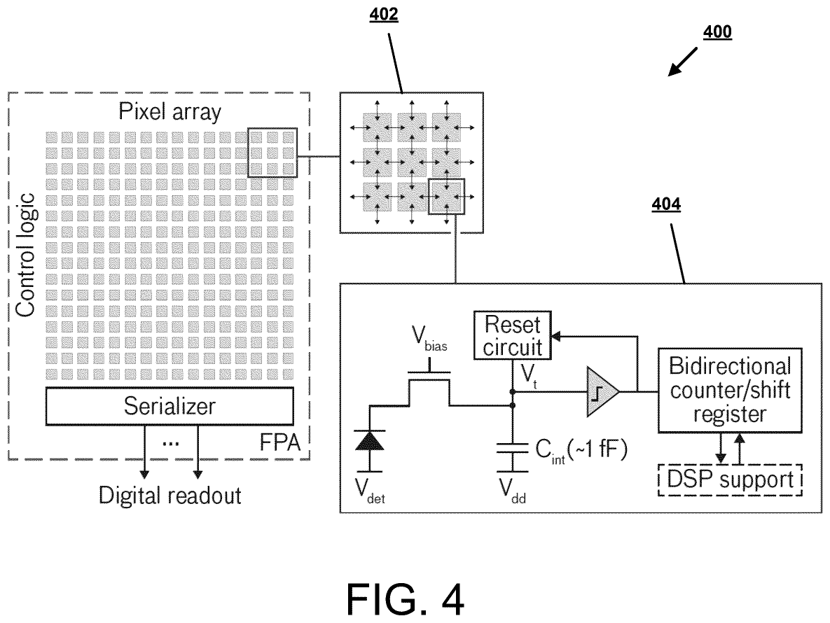

FIG. 4 depicts example components of pixel readout circuitry 400 in accordance with some embodiments of the present disclosure. In some embodiments, the pixel readout circuitry 400 is coupled to the pixel substrate 302. The pixel readout circuitry 400 comprises a digital-pixel readout integrated circuit (DROIC) architecture comprising a plurality of unit-cell circuits 402. A unit-cell circuit 404 of the plurality of unit-cell circuits 402 comprises components including a preamplifier/buffer and an in-pixel analog-to-digital converter (e.g., a photocurrent-to-frequency converter circuit coupled to a bidirectional counter/shift register, multiplexors to connect the counter/shift register to one of four nearest-neighbor unit cells, and pixel timing and control circuits).

In some embodiments, the multi-layer computational structure comprises a HARP module that is configured to (i) generate image data from pixel readout circuitry (e.g., pixel readout circuitry 400), (ii) identify high-level information associated with the image data, and (iii) transfer salient information based on the high-level information to an inference engine (e.g., ICL). In some embodiments, the HARP module may be integrated between the 3D-stacked CMOS image sensor 300 and an application processor (hardware and/or software) that comprises an inference engine.

According to various embodiments of the present disclosure, the HARP module is coupled to an inference engine that comprises a deep learning inference module. The deep learning inference module may be configured by using a region-aware event-based simulator and a configuration generator module to train a machine learning model based on one or more operators and/or event-based models. For example, the region-aware event-based simulator and the configuration generator module may be configured to generate and assess simulation results for one or more system configurations that comprise various physical properties of the photo-sensing elements or image sensors associated with the pixel substrate 302. One or more system configurations may be generated based on the simulations and used to configure the deep learning inference module.

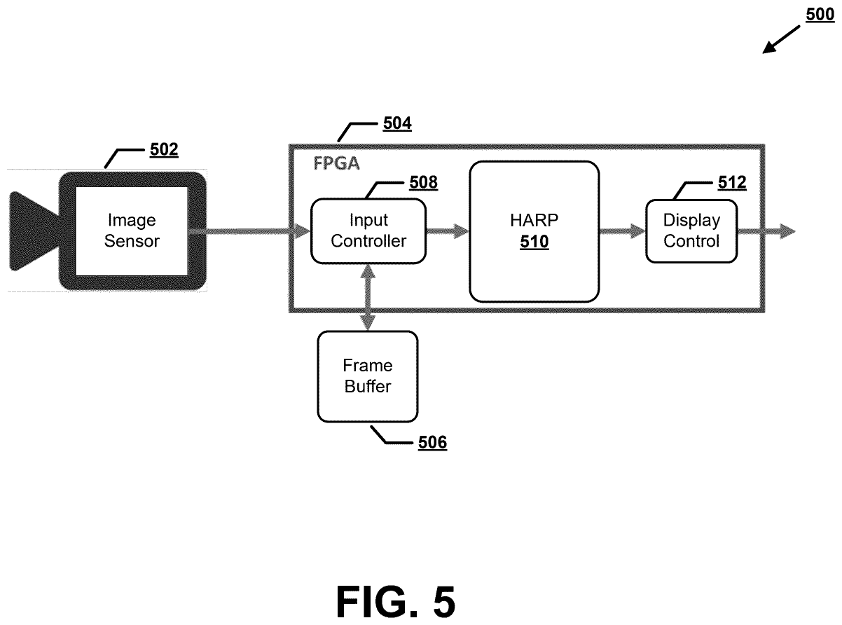

FIG. 5 depicts an example architecture of an in/near-sensor image processing system 500 in accordance with various embodiments of the present disclosure. An image sensor 502 may generate image data for each of a plurality of image frames. The plurality of image frames may be provided by the image sensor 502 to a field-programmable gate array (FPGA) 504. FPGA 504 comprises an input controller 508 that is configured to facilitate storage and retrieval of the plurality of image frames to/from frame buffer 506. In some embodiments, the frame buffer 506 may be configured to provide HARP module 510 with access to at least a portion of the plurality of image frames in parallel such that low-level processing including attention oriented region-based pre-processing of at least a portion of the plurality of image frames may be performed by the HARP module 510. Results and/or data output of low-level processing performed by HARP module 510 may be provided to and handled by a controller or processor, such as display control 512 to display results on a display device or stored in a memory device.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation. It should be understood that the examples and embodiments in the Appendix are also for illustrative purposes and are non-limiting in nature. The contents of the Appendix are incorporated herein by reference in their entirety.

1. An image processing system comprising:
an hierarchical processing device that is configured between readout circuitry of an image sensor and a signal processing unit, wherein the hierarchical processing device comprises:
a first processing circuit layer configured to (i) generate image data that is associated with the image sensor and (ii) generate a subset of the image data by performing pre-processing on the image data, wherein the subset of the image data comprises pixel intensity values that are associated with an image region of a plurality of image regions; and
a second processing circuit layer configured to (i) receive the subset of the image data from the first processing circuit layer and (ii) generate feedback output by performing inference-based processing on the subset of the image data.

2. The image processing system of claim 1, wherein the first processing circuit layer is further configured to sense image regions with a frequency based on the feedback output.

3. The image processing system of claim 1, wherein the first processing circuit layer is configured to generate the subset of the image data by filtering redundant spatiotemporal data from the image data.

4. The image processing system of claim 1 further comprising an in-sensor architecture or a near-sensor architecture.

5. The image processing system of claim 1 further comprising an integration of the image sensor and the first processing circuit layer on a system on a chip.

6. The image processing system of claim 1, wherein the first processing circuit layer comprises an attention-based pre-processing layer that is configured to perform attention-oriented region-based pre-processing on the image data.

7. The image processing system of claim 6, wherein the attention-based pre-processing layer comprises an image acquisition circuit and a region-based processing module.

8. The image processing system of claim 7, wherein the region-based processing module comprises one or more pixel processing elements.

9. The image processing system of claim 6, wherein the attention-based pre-processing layer is coupled to an inference computational layer that comprises the second processing circuit layer.

10. The image processing system of claim 9, wherein the inference computational layer is configured to perform application-specific computations.

11. The image processing system of claim 10, wherein the application-specific computations are associated with object detection or scene recognition.

12. The image processing system of claim 9, wherein the subset of the image data is associated with an image region.

13. A three-dimensional stacked complementary metal-oxide-semiconductor comprising:
a pixel substrate that comprises one or more photo-sensing elements;
a logic substrate that comprises a signal processing unit;
one or more vertical interconnects that transfer pixel intensity values from the pixel substrate to the logic substrate; and
a hierarchical attention-oriented region-based processing module that is coupled to an inference engine, wherein the hierarchical attention-oriented region-based processing module is configured to:
(i) receive image data from pixel readout circuitry that is coupled to the pixel substrate;
(ii) identify high-level information associated with the image data; and
(iii) transfer salient information based on the high-level information to the inference engine.

14. The three-dimensional stacked complementary metal-oxide-semiconductor of claim 13, wherein the inference engine comprises a deep learning inference module.

15. The three-dimensional stacked complementary metal-oxide-semiconductor of claim 14, wherein the deep learning inference module is configured by using a region-aware event-based simulator and a configuration generator module to train a machine learning model based on one or more operators and/or event-based models.

16. The three-dimensional stacked complementary metal-oxide-semiconductor of claim 15, wherein the region-aware event-based simulator and the configuration generator module are configured to generate one or more system configurations based on one or more simulation results that are associated with one or more physical properties of the one or more photo-sensing elements.

17. The three-dimensional stacked complementary metal-oxide-semiconductor of claim 16, wherein the deep learning inference module is configured with the one or more system configurations.

18. An image processing system comprising:
an image sensor that is configured to generate image data for each of a plurality of image frames;
a frame buffer;
a field-programmable gate array that is configured to receive the image data from the image sensor, the field-programmable gate array comprising:
an input controller that is configured to (i) store the plurality of image frames to the frame buffer and (ii) provide access to at least a portion of the plurality of image frames from the frame buffer; and
a hierarchical attention-oriented region-based processing module configured to perform attention oriented region-based processing of at least the portion of the plurality of image frames.
